(19) United States
(12) Patent Application Publication
(10) Pub. No.: US 2008/0105276 A1
(43) Pub. Date: May 8, 2008

(54) METHOD OF IMPROVING SURFACE FLAME RESISTNACE OF SUBSTRATE

(75) Inventors: Shu-Ling Yeh, Taoyuan County (TW); Chin-jiuh Kang, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INDUSTRIAL TECHNOLOGY RESEARCH INSTITUTE, Hsinchu (TW)

(21) Appl. No.: 11/617,735

(22) Filed: Dec. 29, 2006

(30) Foreign Application Priority Data
Sep. 13, 2006 (TW) 95133860

(51) Int. Cl. B08B 7/00

(52) U.S. Cl. 134/1.1

(57) ABSTRACT

A method of improving surface flame resistance of a substrate is provided. A substrate is provided. An atmosphere pressure plasma process is performed on the surface of the substrate to form an inorganic film layer on the surface of the substrate, wherein a process gas of the atmosphere plasma process includes a flame resistance precursor, a carrier gas, and a plasma ignition gas. Particularly, the flame resistance precursor is selected from a siloxane compound, an inorganic alkoxide compound and a combination thereof. The siloxane compound has a formula of Si(OCₙH₂₍ₙ₊₁₎)₄, n=1˜5, and the inorganic alkoxide compound has a formula of A(OCₘH₂ₘ₊₁₎₄, where A represents Sn, Ti, Zr, Ce and m=2.

### CROSS-REFERENCE TO RELATED APPLICATION

This application claims the priority benefit of Taiwan application serial no. 95133860, filed Sep. 13, 2006. All disclosure of the Taiwan application is incorporated herein by reference.

### BACKGROUND OF THE INVENTION

1. Field of the Invention

The present invention relates to a method of improving surface flame resistance of a substrate. More particularly, the present invention relates to a method of improving surface flame resistance of a substrate by using an atmosphere pressure plasma process.

2. Description of Related Art

Since general plastic substrates have poor flame resistance, a flame retardant treatment must be performed on the substrate in order to improve the flame resistance. In current methods of the flame retardant treatment for the plastic substrate, a flame resistance agent containing halogen or nitrogen-phosphate is often used. However, the use of these kinds of chemicals is forbidden by Restriction of Hazardous Substance of European Union, so it has became a key issue of research and development that a precursor free of halogen and phosphorous is used as a flame resistant agent.

Taiwan Patent Application No. 089105175 discloses a phosphorus-free expandable graphite used as the flame resistant agent. However, in this method, a twin-screw device is required to stir the mixture uniformly and the process temperature is limited.

Additionally, Taiwan Patent Application No. 091135494 discloses the use of a flame resistant agent free of halogen and phosphorous to prepare a composition of advanced epoxy resin and epoxy resin. However, this method is merely suitable for an epoxy resin.

In addition, Taiwan Patent Application No. 092133746 discloses an amide or an imide used as a flame resistant agent. However, in this method, an organic substance is used as a flame resistant agent, thus the flame resistance effect is limited.

Currently, an inorganic siloxane can also be used as a flame resistant agent. In this method, a sol is coagulated to perform polymerization, and then the resulting siloxane is dissociated into a solid-liquid coexisting silica component via an acid or base catalytic reaction. However, the polymerization in this method is time-consuming and also a coating process is necessary to coat the resulting solid-liquid coexisting silica component onto the surface of the substrate, followed by a required high temperature baking process. Therefore, this method consumes a long period of time and has complex steps.

### SUMMARY OF THE INVENTION

Accordingly, the present invention is directed to a method of improving surface flame resistance of a substrate. In this method, a precursor free of halogen and phosphorous is used as a flame resistant agent to avoid environmental pollution. The flame resistance precursor used in this method is different from the conventional methods.

In order to achieve the above or other objectives, a method of improving the surface flame resistance of a substrate is provided. A substrate is provided. An atmosphere pressure plasma process is performed on the surface of the substrate to form an inorganic film layer on the surface of the substrate, wherein a process gas of the atmosphere plasma process includes a flame resistance precursor, a carrier gas, and a plasma ignition gas. Particularly, the flame resistance precursor is selected from a siloxane compound, an inorganic alkoxide compound and a combination thereof. The siloxane compound has a formula of Si(OCₙH₂₍ₙ₊₁₎)₄, n=1˜5, and the inorganic alkoxide compound has a formula of A(OCₘH₂ₘ₊₁)₄, where A represents Sn, Ti, Zr, Ce and m=2.

The present invention also provide a method of improving surface flame resistance of a substrate. A substrate is provided. A flame resistance precursor is selected according to the substrate, wherein the flame resistance precursor is selected form a siloxane compound, an inorganic alkoxide compound, and a combination thereof. The siloxane compound has a formula of Si(OCₙH₂₍ₙ₊₁₎)₄, n=1˜5, and the inorganic alkoxide compound has a formula of A(OCₘH₂ₘ₊₁)₄, where A represents Sn, Ti, Zr, Ce and m=2. Subsequently, a plasma ignition gas is charged into an atmosphere plasma device to clean the surface of the substrate and generate active radicals on the surface of the substrate. Then, a carrier gas is introduced to carry the flame resistance precursor into the atmosphere plasma device so that the flame resistance precursor is dissociated into radical molecules the flame resistance precursor. The radical molecules of the flame resistance precursor are chemically bonded with the active radicals on the substrate surface to form an inorganic film layer.

In the present invention, an atmosphere pressure plasma process is adopted and a precursor free of halogen and phosphorous is used as a flame resistant agent to form an inorganic film layer on the substrate, thereby improving the flame resistance of a substrate. Therefore, without using high-temperature vacuum device and solvent contamination, the present invention is advantageous in cost saving and will not cause the problems such as environmental pollutions.

In order to the make aforementioned and other objects, features and advantages of the present invention comprehensible, preferred embodiments accompanied with figures are described in detail below.

### BRIEF DESCRIPTION OF THE DRAWINGS

FIG. 1 is a flow chart of a method of improving the surface flame resistance of a substrate according to an embodiment of the invention.

FIG. 2 is a schematic view of an atmosphere plasma device according to an embodiment of the invention.

### DESCRIPTION OF EMBODIMENTS

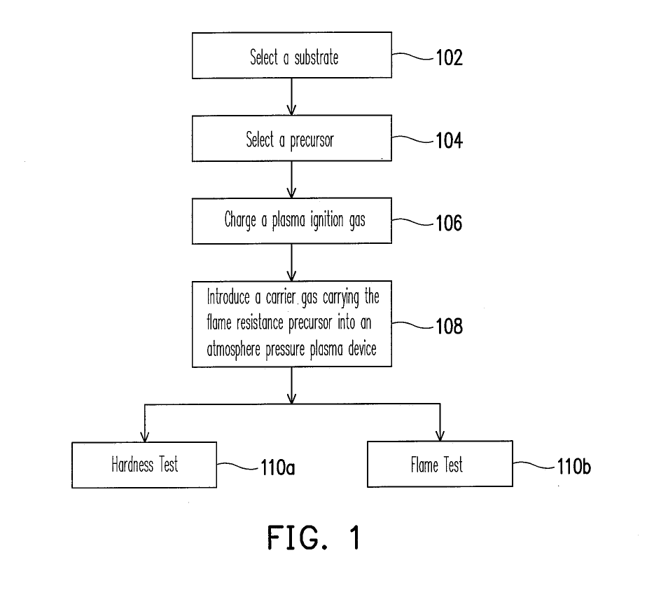

FIG. 1 is a flow chart of a method of improving surface flame resistance of a substrate according to an embodiment of the invention. Referring to FIG. 1, first, a substrate is selected (Step 102). The material of the substrate is, for example, a thermosetting plastic or a thermoplastic plastic. In an embodiment, the thermosetting plastic comprises epoxy resin or other thermosetting plastics. In another embodiment, the thermoplastic plastic comprises acrylonitrile-butadiene-styrene (ABS), polystyrene (PS), or other thermoplastic plastics. Since general plastic substrates have poor flame resistance, a flame retardant treatment must be performed on the substrate in order to improve the flame resistance. However, the method of the present invention is not limited to the plastic substrates only. The method of the present invention can also be applicable to other non-plastic substrates, as long as the substrate is in the need of the flame retardant treatment.

Subsequently, a flame resistance precursor is selected (Step 104). In Step 104, the selection is based on the selection of the substrate. That is, the flame resistance precursor is selected to be suitable for the material of the substrate. Definitely, the flame resistance precursors can also be selected based on the requirements such as, hardness and degree of flame resistance of the flame resistance film layer to be formed on the surface of the substrate.

In one embodiment, the flame resistance precursor is selected from a siloxane compound, an inorganic alkoxide compound and a combination thereof. The siloxane compound has a formula of Si(OCₙH₂₍ₙ₊₁₎)₄, n=1˜5, and the inorganic alkoxide compound has a formula of A(OCₘH₂ₘ₊₁)₄, where A represents Sn, Ti, Zr, Ce and m=2. Particularly, the siloxane compound having a formula of Si(OCₙH₂₍ₙ₊₁₎)₄, n=1˜5 can be used alone as the flame resistance precursor. The inorganic alkoxide compound having a formula of A(OCₘH₂ₘ₊₁)₄, where A represents Sn, Ti, Zr, Ce and m=2 can also be used alone as the flame resistance precursor. Additionally, the flame resistance precursor can be a mixture of the siloxane compound (Si(OCₙH₂₍ₙ₊₁₎)₄) and the inorganic alkoxide compound (A(OCₘH₂ₘ₊₁)₄).

It should be noted that the siloxane compound (Si(OCₙH₂₍ₙ₊₁₎)₄) is, for example, tetraethyl orthosilicate (TEOS). However, the present invention is not limited to this. Particularly, the inorganic film layer formed subsequently is metal alkoxide, silica, siloxane compound or a combination thereof when the siloxane compound (Si(OCₙH₂₍ₙ₊₁₎)₄), inorganic alkoxide compound (A(OCₘH₂ₘ₊₁)₄) or a combination thereof is used as the flame resistance precursor.

Then, the plasma ignition gas is charged (Step 106). That is, a plasma ignition gas is charged into an atmosphere pressure plasma device to clean the surface of the substrate and generate active radicals on the surface of the substrate. In one embodiment, the plasma ignition gas comprises air, nitrogen gas, argon gas, oxygen gas, or a gas mixture of 1-99% oxygen and 99-1% nitrogen. The plasma ignition gas is mainly used to ignite the plasma. After that, the resulting plasma gas bombards the surface of the substrate to clean the surface of the substrate and at the same time generate active radicals on the surface of the substrate.

Subsequently, a carrier gas is introduced to carry the flame resistance precursor into an atmosphere pressure plasma device (Step 108). In one embodiment, the carrier gas comprises air, nitrogen gas, argon gas, oxygen gas, or a gas mixture of 1-99% oxygen and 99-1% nitrogen. The flow rate of the carrier gas is 1-1000 sccm. Thus, the flame resistance precursor is dissociated into radical molecules of the flame resistance precursor by the plasma. And the resulting radical molecules of the flame resistance precursor are chemically bonded with the active radicals on the surface of the substrate to form an inorganic film layer on the surface of the substrate. The material of the inorganic film layer is, for example, a metal alkoxide, silica, a siloxane compound, or a combination thereof. In addition, the atmosphere pressure plasma process is performed with a voltage in a range of 220-270V and a current in a range of 4-8 am, for example.

It should be noted that if the carrier gas used is an oxygen-containing gas, for example, air, oxygen, or a gas mixture of 1-99% oxygen and 99-1% nitrogen, the carrier gas aids to the ignition and generation of the plasma. Thus, the rate of forming an inorganic film layer on the surface of the substrate is increased. Additionally, in the present invention, the surface of the substrate on which the atmosphere pressure plasma process is performed is not limited. That is to say, the atmosphere plasma process can be performed on one, two, or more surfaces of the substrate depending on the practical requirements.

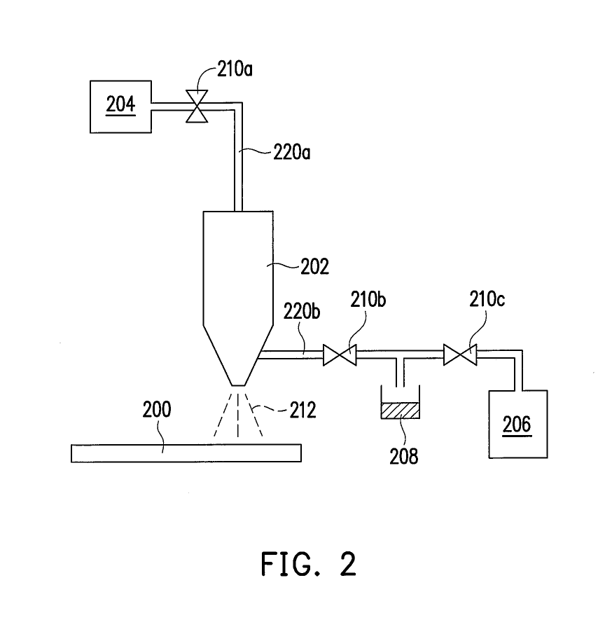

In one embodiment, the method of forming an inorganic film layer on a surface of a substrate employs, for example, the atmosphere pressure plasma device as shown in FIG. 2. Referring to FIG. 2, the atmosphere pressure plasma device includes a plasma nozzle 202, a plasma ignition gas supply unit 204, a carrier gas supply unit 206, a flame resistance precursor supply unit 208, pipe fittings 220a, 220b, and control valves 210a, 210b, 210c. The pipe fitting 220a is connected between the plasma ignition gas supply unit 204 and the plasma nozzle 202, and the control valve 210a is further disposed on the pipe fitting 220a to control the flow of the plasma ignition gas supplied by the plasma ignition gas supply unit 204. The pipe fitting 220b is connected between the carrier gas supply unit 206 and the plasma nozzle 202, and control valves 210b, 210c are further disposed on the pipe fitting 220b. The control valve 210c is used to control the flow of the carrier gas supplied by the carrier gas supply unit 206 and the control valves 210b is used to control the flow of the carrier gas and the flame resistance precursor volatilized from the flame resistance precursor supply unit 208. In addition, the substrate 200 is disposed below the plasma nozzle 202. The process gas 212 ejected by the plasma nozzle 202 is directly ejected to the surface of the substrate 200, so that an inorganic film layer is formed on the surface of the substrate 200. Particularly, the plasma nozzle 202 scans across the surface of the substrate 200 to and fro to deposit an inorganic film layer on the surface of the substrate 200. The method of scanning the surface of the substrate 200 to and fro involves, for example, moving the plasma nozzle 202 while keeping the substrate still, or moving the substrate 200 while keeping the plasma nozzle 202 still. Additionally, the plasma nozzle 202 scans the surface of the substrate to and fro, for example, 1-30 times.

Referring to FIG. 1, after the inorganic film layer is formed on the surface of the substrate, a hardness test (Step 110a) and a flame test (Step 110b) are performed. Thus, the degree of the improvement of the hardness and surface flame resistance of the substrate after the treatment of the atmosphere pressure plasma process of the present invention can be known. Generally, the higher the hardness is, the better the flame resistance is. The results of the hardness test and the flame test shows that the hardness and the flame resistance of the surface of the substrate is improved markedly after the treatment of the atmosphere pressure plasma process of the present invention.

Therefore, in the present invention, an atmosphere pressure plasma process is used to form an inorganic film layer with flame resistance on the surface of the substrate. Thus, the substrate has a flame resistance due to the protection and isolation of the inorganic film layer. That is, the heat will not reach the surface of the substrate due the isolation of the inorganic film layer when the substrate suffers high-temperature burning, so the surface of the substrate has a flame resistance effect.

In the present invention, an atmosphere pressure plasma process is used to dissociate a siloxane compound and/or an inorganic alkoxide precursor into radical molecules which are chemically bonded with the active radicals of the substrate surface to form an inorganic film layer has a compacted microstructure, thereby effectively improving the hardness of the substrate and the flame resistance on the surface.

In addition, in the present invention, the flame resistant agent free of halogen and phosphorous is used. As no solvent is used in the process, environmental pollution and solvent contamination will not occur.

Furthermore, the high-temperature vacuum device is not used in the atmosphere pressure plasma process of the present invention, so the process has the advantages of low cost and short processing time.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of improving surface flame resistance of a substrate, comprising:
providing a substrate; and
performing an atmosphere pressure plasma process on the surface of the substrate to form an inorganic film layer on the surface of the substrate, wherein a process gas of the atmosphere pressure plasma process comprises a flame resistance precursor, a carrier gas, and a plasma ignition gas,
wherein the flame resistance precursor is selected from a siloxane compound, an inorganic alkoxide compound and a combination thereof, the siloxane compound has a formula of Si(OCₙH₂₍ₙ₊₁₎)₄, n=1˜5, and the inorganic alkoxide compound has a formula of A(OCₘH₂ₘ₊₁)₄, where A represents Sn, Ti, Zr, Ce and m=2.

2. The method of improving surface flame resistance of a substrate as claimed in claim 1, wherein the siloxane compound comprises tetraethyl orthosilicate (TEOS).

3. The method of improving surface flame resistance of a substrate as claimed in claim 1, wherein the carrier gas comprises air, nitrogen gas, argon gas, oxygen gas, or a gas mixture of 1-99% oxygen and 99-1% nitrogen.

4. The method of improving surface flame resistance of a substrate as claimed in claim 1, wherein the plasma ignition gas comprises air, nitrogen gas, argon gas, oxygen gas, or a gas mixture of 1-99% oxygen and 99-1% nitrogen.

5. The method of improving surface flame resistance of a substrate as claimed in claim 1, wherein the flow rate of the carrier gas is 1-1000 sccm.

6. The method of improving surface flame resistance of a substrate as claimed in claim 1, wherein the step of performing the atmosphere pressure plasma process on the surface of the substrate comprises scanning the surface of the substrate with a plasma nozzle to and fro.

7. The method of improving surface flame resistance of a substrate as claimed in claim 6, wherein the times of scanning the surface of the substrate of the plasma nozzle to and fro is 1-30.

8. The method of improving surface flame resistance of a substrate as claimed in claim 1, wherein the material of the substrate comprises a thermosetting plastic or a thermoplastic plastic.

9. The method of improving surface flame resistance of a substrate as claimed in claim 8, wherein the thermosetting plastic comprises an epoxy resin.

10. The method of improving surface flame resistance of a substrate as claimed in claim 8, wherein the thermoplastic plastic comprises acrylonitrile-butadiene-styrene (ABS) or polystyrene (PS).

11. The method of improving surface flame resistance of a substrate as claimed in claim 1, wherein the material of inorganic film layer comprises a metal alkoxide, silica, an alkoxide compound or a combination thereof.

12. A method of improving surface flame resistance of a substrate, comprising
selecting a substrate;
selecting a flame resistance precursor according to the substrate, wherein the flame resistance precursor is selected from a siloxane compound, an inorganic alkoxide compound and a combination thereof, the siloxane compound has a formula of Si(OCₙH₂₍ₙ₊₁₎)₄, n=1˜5, and the inorganic alkoxide compound has a formula of A(OCₘH₂ₘ₊₁)₄, where A represents Sn, Ti, Zr, Ce and m=2;
charging a plasma ignition gas into an atmosphere pressure plasma device to clean the surface of the substrate and generate active radicals on the surface of the substrate;
introducing a carrier gas to carry the flame resistance precursor into the atmosphere pressure plasma device so that the flame resistance precursor is dissociated into radical molecules of the flame resistance precursor, wherein the radical molecules of the flame resistance precursor are chemically bonded with the active radicals on the substrate surface to form an inorganic film layer on the surface of the substrate.

13. The method of improving surface flame resistance of a substrate as claimed in claim 12, wherein the siloxane compound comprises tetraethyl orthosilicate (TEOS).

14. The method of improving surface flame resistance of a substrate as claimed in claim 12, wherein the carrier gas comprises air, nitrogen gas, argon gas, oxygen gas, or a gas mixture of 1-99% oxygen and 99-1% nitrogen.

15. The method of improving surface flame resistance of a substrate as claimed in claim 12, wherein the ignition gas comprises air, nitrogen gas, argon gas, oxygen gas, or a gas mixture of 1-99% oxygen and 99-1% nitrogen.

16. The method of improving surface flame resistance of a substrate as claimed in claim 12, wherein the flow rate of the carrier gas is 1-1000 sccm.

17. The method of improving surface flame resistance of a substrate as claimed in claim 12, wherein the step of performing the atmosphere pressure plasma process on the surface of the substrate comprises scanning the surface of the substrate with a plasma nozzle to and fro.

18. The method of improving surface flame resistance of a substrate as claimed in claim 17, wherein the times of scanning the surface of the substrate of the plasma nozzle to and fro is 1-30.

19. The method of improving surface flame resistance of a substrate as claimed in claim 12, wherein the material of the substrate comprises a thermosetting plastic or a thermoplastic plastic.

20. The method of improving surface flame resistance of a substrate as claimed in claim 19, wherein the thermosetting plastic comprises an epoxy resin.

21. The method of improving surface flame resistance of a substrate as claimed in claim 19, wherein the thermoplastic plastic comprises acrylonitrile-butadiene-styrene (ABS) or polystyrene (PS).

22. The method of improving surface flame resistance of a substrate as claimed in claim 12, wherein the material of inorganic film layer comprises a metal alkoxide, silica, or an alkoxide compound, or a combination thereof.
